(19) United States
(12) Patent Application Publication
(10) Pub. No.: US 2020/0120621 A1
(43) Pub. Date: Apr. 16, 2020

(54) Pre-Provisioned Group Communications

(71) Applicant: Telefonaktiebolaget LM Ericsson (publ), Stockholm (SE)

(72) Inventors: Magnus Tränk, Lerum (SE); Daniel Guldbrand, Ödsmål (SE)

(21) Appl. No.: 15/770,525

(22) PCT Filed: Apr. 5, 2018
(86) PCT No.: PCT/EP2018/058775

§ 371 Date: Apr. 24, 2018

(51) Int. Cl. H04W 56/00; H04W 4/50; H04W 4/90; H04W 4/021; H04W 4/08; H04W 4/029; H04W 76/15; H04W 76/14; H04W 4/10

(52) U.S. Cl. CPC H04W 56/001; H04W 4/50; H04W 4/90; H04W 4/021; H04W 4/10; H04W 4/029; H04W 76/15; H04W 76/14; H04W 4/08

(57) ABSTRACT

A method in a Group Communications, GC, server node (110) comprising a central GC server (111), for synchronizing GC data between the central GC server (111) and a local GC server (230) comprised in a local GC server node (120). The method comprises performing a GC registration procedure in the central GC server (111) involving a GC client (310) comprised in a wireless device (140), receiving a location report related to a location of the wireless device (140), associating the location report with a GC capability of the local GC server node (120) of providing GC involving the GC client (310), and transmitting GC service data related to the GC client (310) to the local GC server (230).

### TECHNICAL FIELD

The present disclosure relates to group communications in communication networks, and to mission critical network services. The disclosure also relates to Isolated E-UTRAN Operations for Public Safety (IOPS).

### BACKGROUND

Mission Critical (MC) communication services are essential for the work performed by public safety users such as police and fire brigade personnel. The MC communications service requires preferential handling compared to normal telecommunication services including handling of prioritized MC calls for emergency and imminent threats. Furthermore, MC communication services require several resilience features that provide a guaranteed service level even if part of the network or backhaul infrastructure fails.

The most commonly used communication method for public safety users is Group Communication (GC) where the same information is delivered to multiple users. One type of Group Communication is Push to Talk (PTT) service. A Group Communication system can be designed with a centralized architecture approach, in which a centralized GC control node provides full control of all GC service data, such as group membership, policies, user authorities and prioritizations. Such an approach requires a network infrastructure that provides high network availability. This type of operation is sometimes known as Trunked Mode Operation (TMO) or on-network operation.

A different approach is a design where each or a sub-set of user radio devices are taking part in controlling the group communication. In this case the GC service data, and/or group data, must be pre-provisioned to each device. This type of solution is sometimes known as Direct Mode Operation (DMO) or off-network operation, which means that GC can take place without any support, or with limited support, from network infrastructure.

In incumbent GC systems both approaches mentioned above are supported. Furthermore, incumbent GC systems may provide a resilience feature that allows a local radio base station to provide local connectivity and GC to users in proximity of the local radio base station, even if the local radio base station loses it connections to other parts of the network. This is in some deployments known as Local Site Trunking.

In a 3GPP based network that provides GC services like Mission Critical Push To Talk (MCPTT), the service can be guaranteed even in the case of backhaul failure by using a feature known as Isolated E-UTRAN Operations for Public Safety (IOPS). This feature is described in, e.g., 3GPP TS 23.401 v15.1.0, Annex K. The IOPS functionality provides local connectivity to the public safety users' devices that are within communication range of the E-UTRAN radio base station (eNB) that supports IOPS.

One way to provide IOPS in a 3GPP based network is to deploy a packet core network in each radio base station, i.e., a local packet core network. This network may be an evolved packet core network (EPC). This includes a user database comprising user identities and authentication keys.

To provide GC with an acceptable service level in IOPS, as described in 3GPP TS 23.401 v15.1.0, it is required that the GC service data is synchronized between a centralized GC control node and the local GC application that resides in the radio base station that will provide the resilience feature IOPS. Additionally, user data including security materials, such as user credentials and authentication keys must be synchronized between the centralized user database and the local radio base stations core network functionality. There may be many IOPS capable radio base stations in a network, each requiring synchronization. This results in a synchronization challenge in known GC systems using IOPS solutions or similar. Not only the amount of data is a problem, but the data must also be maintained regularly to stay relevant, and constant cross-checking between data registers are therefore necessary. Hence, there is a need for improved methods for data synchronization in GC systems.

### SUMMARY

It is an object of the present disclosure to provide improved methods and devices for synchronization of GC service data.

This object is obtained by a method in a Group Communications (GC) server node comprising a central GC server, for synchronizing GC data between the central GC server and a local GC server comprised in a local GC server node. The method comprises performing a GC registration procedure in the central GC server involving a GC client comprised in a wireless device, receiving a location report related to a location of the wireless device, associating the location report with a GC capability of the local GC server node of providing GC involving the GC client, and transmitting GC service data related to the GC client to the local GC server.

The object is also obtained by a method in a wireless device comprising a GC client for synchronizing group communication data between a central GC server and a local GC server comprised in a local GC server node in proximity of the wireless device. The method comprises performing a GC registration procedure involving the GC client and the central GC server, transmitting a location report to the central GC server, and obtaining an indication relating to a group communication capability of the local GC server node.

The object is also obtained by a method in a local Group communication (GC) server node for synchronizing GC data between a central GC server and a local GC server comprised in the local GC server node. The method comprises receiving GC service data related to the GC client from the central GC server, and, following a link outage between the local GC server node and the central GC server, or between the GC client and the central GC server, performing a handshake procedure for group communication involving the GC client and the local GC server.

Advantageously, a reduced complexity in synchronizing GC service data between the central GC server and the local GC server is hereby obtained. The synchronization is only done based on need, hence not all radio base stations in a network are required to have an updated GC service data configuration. This provides a more efficient way to handle a transition to, e.g., IOPS, since the GC client and the local GC server can be prepared or pre-provisioned for IOPS operation prior to failure in network infrastructure communications involving the central GC server.

The disclosed methods advantageously limit the GC synchronization scope to active users and groups. Thus, a more efficient synchronization procedure is obtained.

Further advantages are obtained by the dependent claims.

Apart from the above methods, there is also provided herein devices and computer programs comprising computer program code corresponding to the methods. The devices and computer programs display advantages corresponding to the advantages already described in relation to corresponding above-mentioned methods.

### BRIEF DESCRIPTION OF THE DRAWINGS

The present disclosure will now be described in more detail with reference to the appended drawings, where

FIG. 1 shows a schematic view of a communication system;

FIG. 2 shows a schematic view of a network node;

FIG. 3 shows a schematic view of a wireless device;

FIG. 4 illustrates a sequence of events in a communication system according to aspects of the present disclosure;

FIG. 5 shows a flowchart illustrating methods performed in a server node according to aspects of the present disclosure;

FIG. 6 shows a flowchart illustrating methods performed in a wireless device according to aspects of the present disclosure;

FIG. 7 shows a flowchart illustrating methods performed in a server node according to aspects of the present disclosure;

FIGS. 8-9 schematically illustrate a server node according to aspects of the present disclosure;

FIGS. 10-11 schematically illustrate a wireless device according to aspects of the present disclosure;

FIGS. 12-13 schematically illustrate a server node according to aspects of the present disclosure;

FIG. 14 schematically illustrates a computer readable medium;

### DETAILED DESCRIPTION

Aspects of the present disclosure will now be described more fully with reference to the accompanying drawings. The different devices, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The proposed solutions and techniques provide a synchronization method between a centralized GC system, a GC client and a local GC system that is deployed in an IOPS capable eNodeB or similar, as discussed in, e.g., 3GPP TS 23.401 v15.1.0, Annex K.

It is appreciated that, although the main concepts herein are exemplified using an IOPS system, the disclosure is not limited to use together with IOPS as described in 3GPP TS 23.401 v15.1.0 but is applicable also in similar systems involving a central server arranged to control group communications, and local servers configured to take over group communications support in case of network infrastructure failure.

Herein, data, GC data, GC service data, GC user data, and similar terms, are used interchangeably and refer to data items relevant for establishing and maintaining group communication. Such data comprises, for example one or more of: group membership, group affiliations, policies, user authorities, prioritizations, authorization keys, and the like. For example, an important communication type is Mission Critical Push To Talk (MCPTT) services. A complete MCPTT system requires extensive user, service, and group configuration data, herein all referred to as GC service data. In an MCPTT system compliant with 3GPP TS 23.179 V13.5.0 there is an MCPTT user profile defined with several parameters, that controls one or more of the: user access, service settings, contact list, authorization parameters etc. There is also group configuration that includes one or more of: group identities, group memberships, group call control attributes like affiliation statues and prioritizations. GC service data refers, e.g., to such data items.

According to aspects, GC service data comprises 3rd party registration data transferred during a 3rd party registration procedure. This type of data is discussed, e.g., in Internet Engineering Task Force (IETF) RFC 3261-SIP: Session Initiation Protocol. 3rd party registration data and procedures in the context of group communication systems are known and will not be discussed in detail here. It is, however, appreciated that the central GC server may advantageously make use of 3rd party registration mechanisms when transferring GC service data to a local GC server.

3GPP TS 23.179 v13.5.0 discusses group affiliations in relation to group communications. In general, group affiliations relate to a mechanism by which, e.g., an MCPTT user's interest in one or more MCPTT groups is determined.

According to an example of the present disclosure, the synchronization of data between a central GC server and a local GC server is triggered by the GC clients that are located within the coverage or in proximity of an IOPS capable eNB or similar prior to the, e.g., backhaul failure and IOPS mode. The proposed methods will also leverage on the group affiliations information indicating the association with a GC group for a wireless device (GC client), to synchronize a larger set of users and service data, which is likely to be used in the area of the IOPS capable eNB. However, all user data available to the central GC server is not synchronized with all local GC servers. Instead, only data relevant to users located in a specific geographic area, or in a specific part of the network, is synchronized. This reduces synchronization burden in the network considerably.

Herein, the term proximity is given a broad interpretation to mean geographical proximity, and also network proximity. Thus, two devices located in the same part of a network, e.g., in the same IP sub-net or domain served by the same core network section can be in proximity to each other even though the geographical distance is large. Also, a part of a network may become isolated from other parts of the network when the infrastructure fails at some point. However, those isolated network nodes and wireless device may be distributed across a geographically large area, depending on network configuration. Therefore, a wireless device located geographically close to a network node may or may not be in proximity of the network node, depending on how the network is configured.

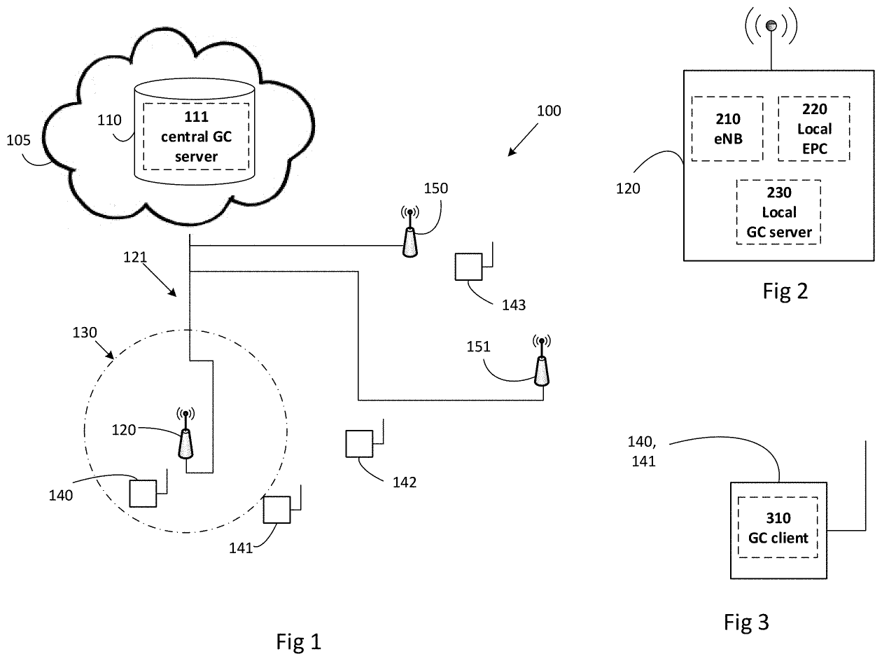

FIG. 1 shows a schematic view of a communication system 100 where the concepts disclosed herein are applicable. A number of wireless devices 140, 141, 142, 143 are located throughout an area comprising a number of radio base stations 120, 150, 151. The radio base stations are connected via, e.g., backhaul communication links 121 to a core network 105.

The core network 105 comprises a GC server node 110, which implements or comprises a central GC server 111. The central GC server manages group communications in the area. For instance, the central GC server maintains updated GC service data necessary for providing GC services throughout the area.

The different radio base stations are associated with respective coverage areas 130. A wireless device 140 located within a coverage area 130 is able to communicate to and/or from the radio base station.

The backhaul communication link 121 may fail due to various reasons. When this happens the radio base station 120 may lose connectivity to the central GC server 111 and will then be isolated from the central GC system. If no action is taken, GC service in the coverage area of the isolated radio base station may be affected.

A radio base station resilience feature known as IOPS is known, especially in relation to public safety users such as police and fire brigade personnel. IOPS is discussed in, e.g., 3GPP TS 23.401 v15.1.0 Annex K. The IOPS feature can provide local connectivity to the wireless devices 140, 141, in the case when there is a link failure to the core network 105. The IOPS feature can be used in different types of deployments. One common scenario is when radio base station 120 is located on a remote location (e.g. an island) and the radio base station is connected to the core network via e.g. a satellite link. If there is a satellite link failure, it is critical for Public Safety users to be able to at least have local connectivity for the communication between the users in the coverage 130 of the radio base station 120.

To public safety users an important communication type is Group Communication (GC), for example Mission Critical Push To Talk (MCPTT) services. A complete MCPTT system requires extensive user, service, and group configuration data, herein referred to as GC service data, as discussed above.

When using IOPS or similar there must be a local GC system that can serve the users. This serving requires that the database of the local GC system is synchronized, or sufficiently synchronized, with the centralized GC system which is used when IOPS or similar is not active. The synchronization of user/service data is complex both due to the extensive data model, but also due to the large number of radio base station that should support IOPS.

The herein proposed solution synchronizes the state of the centralized GC server 111 to the local GC server 230 based on the current registered users and ongoing group activities. Advantageously, a reduced complexity in synchronizing GC service data between the central GC server and the local GC server is obtained as a result. This is at least partly due to that the synchronization is only done based on need, hence not all radio base stations in a network are required to have an updated GC service data configuration. This provides a more efficient way to handle a transition to, e.g., IOPS, since the GC client and the local GC server can be prepared or pre-provisioned for IOPS operation prior to failure in communications involving the central GC server.

In other words, the method limits the synchronization scope to the active users and groups. Thus, a more efficient synchronization procedure is obtained.

FIG. 2 shows a schematic view of a network node 120. The network node 120 exemplifies the network node 120 shown in FIG. 1. This network node 120 comprises an eNB 210, a local evolved packet core (EPC) 220 and a local GC server 230.

FIG. 3 shows a schematic view of a wireless device 140, 141. The wireless device exemplifies wireless devices 140, 141 in FIG. 1. The wireless device 140 comprises a GC client 310. For example, the wireless device may be capable of MCPTT or similar. Wireless device 140 is within radio coverage of the network node 120 and may thus benefit from local GC support by the network node 120. Wireless device 141 is in geographical proximity of the network node 120 and may thus benefit of local GC support in case it moves into radio coverage of the network node 120.

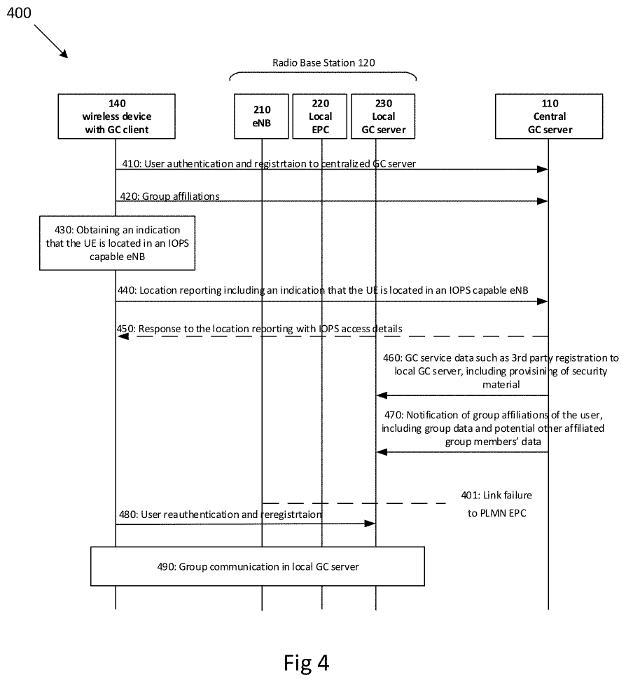

FIG. 4 illustrates an example sequence of events 400 in a communication system 100 according to aspects of the present disclosure. There is shown an exchange between a wireless device 140 a radio base station 120 and a central GC server 110. The wireless device comprises a GC client. The radio base station 120 comprises an eNB 210, a local EPC 220, and a local GC server 230.

The method is performed both prior and after a link failure 401 between the Radio Base Station 120, and the centralized public land mobile network (PLMN) core network, i.e., before connection 121 to the central GC server 111 is lost.

Herein, link failure refers to any event which interrupts or negatively affects the ability of the central GC server to provide GC support. It can for instance be a physical link failure due to a broken optical fiber link, or it can be a reduced throughput condition over a microwave link due to heavy rain, or it can be a partial network outage condition due to a network configuration error.

The GC client installed on the wireless device 140 initially performs a registration procedure 410 and preferably also an authentication procedure. This could for example be done based on the 3GPP MC common architecture framework, ref TS 23.280 v 15.2.0.

The GC client then affiliates 420 to all GC groups that the user of the wireless device 140 is interested to take part in.

The wireless device obtains 430 an indication from the radio network or other source that the wireless device is located within the coverage or in proximity of a radio base station or network node that is IOPS capable. This indication can be either broadcasted from the radio base station, be informed by the centralized GC server or be preconfigured in either GC system. This indication can also be a geographical position or an identity of a radio base station in proximity of the wireless device. It can for instance be a list of radio base stations which the wireless device can hear radio transmissions from.

The wireless device reports 440 the indication data to the GC server in a location report.

Optionally the GC server could respond 450 to the GC client with additional IOPS related information, e.g. access details to a local GC server, and temporary data that may be used in IOPS mode.

The centralized GC server then executes a 3rd party registration 460 of the GC client to the local GC server, this also optionally includes security associations. This will be needed later on in case of a link failure to the PLMN EPC network. The 3rd party registration is an example of transferring GC service data.

According to aspects, a subset of the GC data is pre-configured in the local GC server, and a complement of the data is sent from the central GC server to the local GC server in the registration 460.

The centralized GS server may also send group configuration data 470 for the groups that the GC client has affiliated to. The purpose of this is to synchronize the service data between the centralized and local GC system. This step may also include information on other users, based on e.g. users located in neighboring cells or in cells that are in the same geographical area. This may also be based on the current state of group affiliations to the groups that the GC client has affiliated to.

A link failure 401 occurs which severs the radio base station with the local GC server from the central GC server and from other network resources, e.g., in the PLMN EPC network. This will trigger the eNB to enter IOPS mode as specified in 3GPP TS 23.401 v15.1.0 Annex K. After the link failure, a part of the network comprising the local GC server is isolated from another part of the network which comprises the central GC server.

Following the link failure 401, the GC client performs a handshake procedure with the local GC server to establish GC supported by the local GC server 230 instead of the central GC server 110. This handshake, according to aspects, comprises re-registration and optionally also authentication.

GC communication can now continue between the users that are attached to the eNB 210 in IOPS mode and with the local GC system.

The advantages with this local synchronization concept compared to synchronizing on a larger scale are significantly reduced complexity in synchronizing the GC service data between a centralized GC system and the local GC system in radio base stations, especially in the case of IOPS. The synchronization is also only done based on need, hence not all radio base station in a network are required to have an updated GC service data configuration. This provides a more efficient way to handle a transition to, e.g., IOPS, since the GC client and the local GC server can be prepared or pre-provisioned for IOPS.

One main idea of this solution is to provide an optimized GC service data synchronization method when utilizing the IOPS functionality in a 3GPP based network. The method limits the synchronization scope to the active users and groups relevant to a given geographical area.

According to aspects, the concept of area is defined based on other characteristics than merely geographical location, for instance based on operator identity or network structural properties such as IP address.

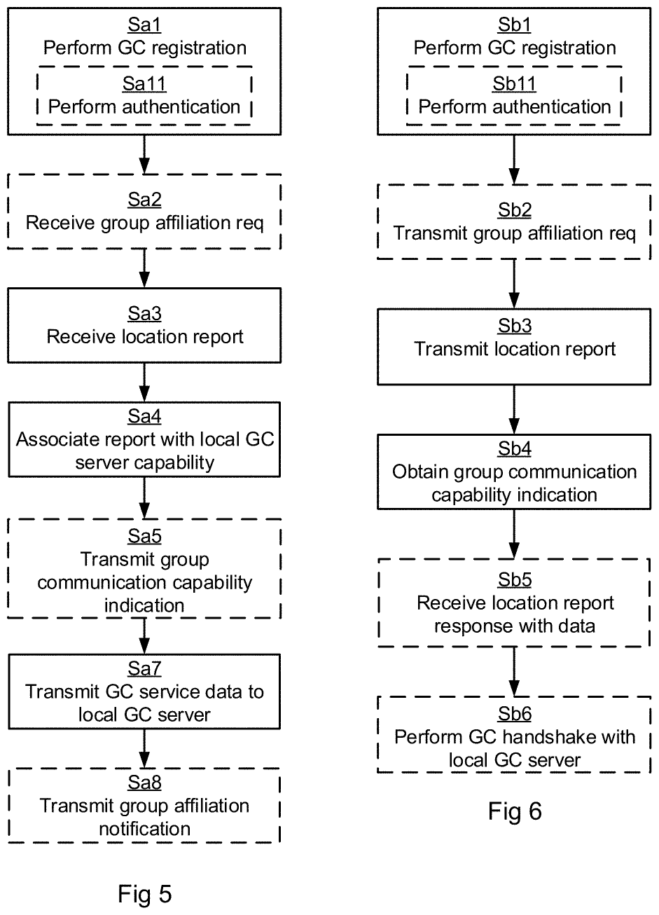

FIG. 5 shows a flowchart illustrating methods performed in a GC server node according to aspects of the present disclosure. This method is a more general method compared to the example in FIG. 4, applicable also to systems other than IOPS.

There is shown a method in a Group Communications, GC, server node 110 comprising a central GC server 111, for synchronizing GC data between the central GC server 111 and a local GC server 230 comprised in a local GC server node 120. The method comprises performing Sa1 a GC registration procedure in the central GC server 111 involving a GC client 310 comprised in a wireless device 140. This registration procedure is, according to aspects a normal registration procedure which a GC client executes before it can take part in GC. This could for example be done based on the 3GPP MC common architecture framework, ref TS 23.280 v 15.2.0. The registration procedure Sa1 can e.g. be done according to registration procedure 410 in FIG. 4.

The method also comprises receiving Sa3 a location report related to a location of the wireless device 140. As mentioned above, the location report can include different types of information. The location report can contain a single type of information or a combination of different types of information. For instance, the location report may comprise any of a geographical location in terms of coordinates, an identity of a serving network node or radio base stations, a list of radio base stations in proximity of the wireless device, an IP address, MAC address or network structure data associated with the wireless device. The location report enables the central GC server 111 to identify one or more local GC servers that are relevant to synchronize GC service data with. The location report Sa3 can e.g. be done according to the location report 440 in FIG. 4.

The method also comprises associating Sa4 the location report with a GC capability of the local GC server node 120. This GC capability refers to a capability of providing group communication in local connectivity involving the GC client 310. It is appreciated that the local GC server node may be comprised in a radio base station serving the wireless device, but it may also be a local GC server node in proximity of the wireless device, such as a radio base station within reach of the wireless device, or otherwise in proximity of the wireless device. In summary, the local GC server node 120 is, according to aspects, not necessarily a serving node. It could also be that the wireless device is in proximity of a serving node with said capability. It could also be that the local GC server node is connected to the serving node via backhaul.

The method also comprises transmitting Sa7 GC service data, such as 3rd party registration data, related to the GC client 310 to the local GC server 230. The transmitting Sa7 can e.g. be done according to step(s) 460 and/or 470 in FIG. 4.

Thus, efficient synchronization of GC service data between central GC server and local GC server is obtained. As noted above, the synchronization is not necessarily a total synchronization of all relevant service data. Some parts of the service data may be pre-provisioned prior to the 3^{rd} party registration is executed, in which case the 3^{rd} party registration procedure only synchronizes or updates a subset of the GC service data.

According to aspects, the performing Sa1 comprises performing Sa1 an authentication procedure.

According to aspects, the performing Sa1 comprises performing a registration procedure according to 3GPP Mission Critical common architecture framework, TS 23.280 v 15.2.0.

The initial set-up procedure comprising registration, according to aspects, comprises receiving Sa2 a group affiliation request associated with the GC client 310, from the wireless device 140.

According to some aspects, the method comprises transmitting Sa5 an indication to the wireless device 140 relating to a group communication capability of the local GC server node 120. The transmitting may be performed in a variety of different ways. The GC server node may for instance send a message directly to the wireless device comprising the GC client with information about GC capabilities in an area where the wireless device is located, or about GC capabilities in a network where the wireless device is comprised.

According to some aspects, the method comprises transmitting Sa8 a notification comprising data related to group affiliations associated with the GC client 310 to the local GC server 230. The data, according to aspects, also comprises GC service data related to other GC clients associated with the group affiliations.

According to aspects, the group communication capability is an Isolated E-UTRAN operations for Public Safety, IOPS, capability. However, it is appreciated that the general concepts disclosed herein are applicable to a wide variety of systems and is not limited to IOPS capability.

According to aspects, the local GC server node 120 is a serving network node of the wireless device 140. According to some other aspects, the local GC server node 120 is a network node is within the coverage or in proximity of the wireless device 140. Thus, the local GC server node 120 may be comprised in the radio base station serving the wireless device. However, the local GC server can also be a radio base station in a vicinity of the wireless device. For example, the wireless device may be served by a pico-cell in an area, while the local GC server may be comprised in a macro-cell which covers a location of the wireless device. The local GC server may also be comprised in a radio base station located in a vicinity of the wireless device but not within radio coverage of the wireless device.

In general, it is appreciated that a link failure or backhaul link failure may isolate parts of a network from other parts of the network. It may happen that the central GC server becomes isolated from a section of the network. Then, as long as this section comprises the local GC server according to the discussion herein, group communications can be maintained as long as the local GC server remains connected to a radio base station within radio coverage of the wireless device comprising the GC client.

FIG. 6 shows a flowchart illustrating methods performed in a wireless device according to aspects of the present disclosure. This wireless device is the same wireless device 140 discussed in connection with FIGS. 1 and 3 above.

The wireless device comprises a Group Communication, GC, client 310 for synchronizing group communication data between a central GC server 111 and a local GC server 230 comprised in a local GC server node 120 in proximity of the wireless device. The central GC server is the same server as that discussed in connection to FIG. 5.

The method comprises performing Sb1 a GC registration procedure involving the GC client 310 and the central GC server 111. This registration procedure was discussed in connection to FIG. 5 above.

The method also comprises transmitting Sb3 a location report to the central GC server 111. As mentioned above, the location report may according to some aspects comprise a geographical location obtained from, e.g., a Global Positioning System (GPS) transceiver or similar. According to other aspects the location report comprises any of a serving node identity, tracking area identity, global cell identity, a network identity, a MAC address, and such, which can be used to identify where in the network structure the wireless device is located. The location report therefore enables the central GC server to identify a local GC server with which to perform, e.g., a 3rd party registration discussed above.

The method further comprises obtaining Sb4 an indication relating to a group communication capability of the local GC server node 120. As mentioned above, the group communication capability may be an IOPS capability, but may also be other group communication capabilities. Also, the capability is, according to aspects, related to the network node serving the wireless device. According to some other aspects, the capability is related to a network node in a proximity of the wireless device, which may be different from the serving network node.

According to aspects, the performing Sb1 comprises performing Sb11 an authentication procedure.

According to aspects, the method comprises transmitting Sb2 a group affiliation request associated with the GC client 310 to the central GC server 111. The group affiliation request data enables the central GC server to establish relevant group data associated with the GC client comprised in the wireless device 140. The group data enables the central GC server to also configure synchronization with the local GC server of additional service data related to GC clients comprised in the groups.

According to aspects, the method comprises receiving Sb5 a response to the transmitted location report from the central GC server 111, wherein the response comprises data related to a group communication capability of the local GC server node 120. This way the GC client in the wireless device is made aware of GC capabilities in network nodes in proximity of the wireless device.

According to aspects, the method comprises performing Sb6 a handshake procedure for group communication involving the GC client 310 and the local GC server 230 following a link outage between the local GC server node 120 and the central GC server 111, or between the GC client and the central GC server. This handshake procedure may also be a notification sent to the local GC server informing about the link outage. The handshake procedure may also be a re-registration with the local GC server. According to some aspects, the handshake procedure enables a seamless transition from group communications supported by the central GC server to group communications supported by the local GC server.

Herein, link outage is interpreted broadly to refer to any cause of communication loss between the central GC server and the local GC server and/or the GC client. For instance, it may refer to link outage caused by a broken cable, or to link outage caused by a reduced throughput of a microwave link due to severe rain, or it may refer to link outage or reduced link performance due to traffic overload over a wireless or wireline connection.

According to aspects, relevant service data in the central GC server is mirrored in the local GC server. This way, the users may not even note that the group communications is transferred to the local GC server, since the service may be seamlessly transferred from the central to the local GC server.

According to aspects, the group communication capability is an Isolated E-UTRAN operations for Public Safety, IOPS, capability.

According to aspects, the local GC server node 120 is a serving network node of the wireless device 140. According to other aspects, the local GC server node 120 is a network node in proximity of, or connected via backhaul to, the wireless device 140. These aspects were discussed above in connection to FIG. 5.

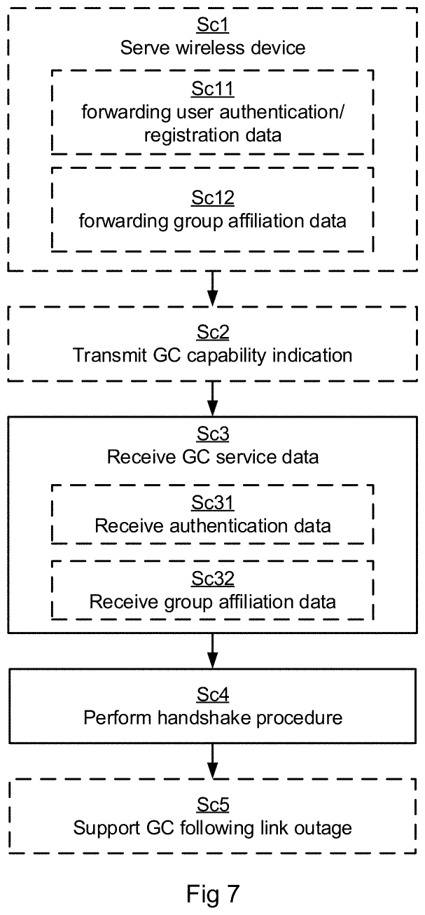

FIG. 7 shows a flowchart illustrating methods performed in a server node according to aspects of the present disclosure.

There is illustrated a method in a local GC server node 120 for synchronizing Group Communication, GC, data between a central GC server 111 and a local GC server 230 comprised in the local GC server node.

The method comprises receiving Sc3 GC service data related to the GC client 310 from the central GC server 111, and, following a link outage between the local GC server node 120 and the central GC server 111, or between the GC client and the central GC server, performing Sc4 a handshake procedure for group communication involving the GC client 310 and the local GC server 230. Thus, the group communications support is taken over by the local GC server when connection to the central GC server is lost. This means that group communications can be continued over a local area supported by the local GC server even if the connection to parts of the network comprising the central GC server is lost.

According to aspects, the local GC server node 120 comprises an evolved NodeB 210, eNB, a local Evolved Packet Core 220, EPC, and the local GC server 230. This local GC server node was discussed in connection to FIG. 2 above.

According to aspects, the receiving Sc3 comprises receiving Sc31 data related to an authentication of the GC client 310.

According to aspects, the receiving Sc3 comprises receiving Sc32 data related to a group affiliation of the GC client 310.

According to aspects, the method also comprises supporting Sc5 a group communication involving the GC client 310 following link outage between the local GC server node 120 and the central GC server 111. Thus, GC is maintained despite link outage. The link outage may have isolated the network node and the wireless device from the rest of the network, or it may have isolated a part of the network from another part of the network which comprises the central GC server. In either case, due to the general concept of pre-provisioning discussed here, GC may be continued to be supported despite the link outage.

According to aspects, the local GC server node 120 comprises an Isolated E-UTRAN operations for Public Safety, IOPS, capability.

According to aspects, the local GC server node 120 is a serving network node of the wireless device 140.

According to aspects, the local GC server node 120 is a network node in proximity of the wireless device 140.

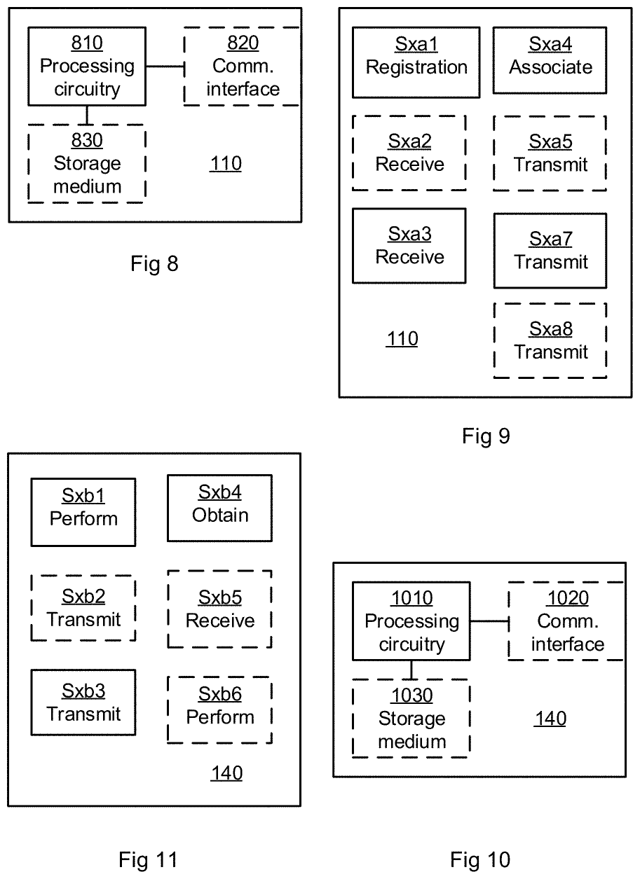

FIGS. 8-9 schematically illustrate a server node according to aspects of the present disclosure. It is appreciated that the above described methods may be realized in hardware. This hardware is then arranged to perform the methods, whereby the same advantages and effects are obtained as have been discussed above.

FIG. 8 schematically illustrates, in terms of a number of functional units, the components of a GC server node 110 hardware according to an embodiment of the above discussions. Processing circuitry 810 is provided using any combination of one or more of a suitable central processing unit CPU, multiprocessor, microcontroller, digital signal processor DSP, etc., capable of executing software instructions stored in a computer program product, e.g. in the form of a storage medium 830. The processing circuitry 810 may further be provided as at least one application specific integrated circuit ASIC, or field programmable gate array FPGA.

Particularly, the processing circuitry 810 is configured to cause the GC server node 110 to perform a set of operations, or steps. For example, the storage medium 830 may store the set of operations, and the processing circuitry 810 may be configured to retrieve the set of operations from the storage medium 830 to cause the GC server node 110 to perform the set of operations. The set of operations may be provided as a set of executable instructions. Thus, the processing circuitry 810 is thereby arranged to execute methods as herein disclosed.

The storage medium 830 may also comprise persistent storage, which, for example, can be any single one or combination of magnetic memory, optical memory, solid state memory or even remotely mounted memory.

The GC server node 110 may further comprise a communications interface 820 for communications with at least one external device. As such the communication interface 820 may comprise one or more transmitters and receivers, comprising analogue and digital components and a suitable number ports for wireline or wireless communication.

The processing circuitry 810 controls the general operation of the node 110 e.g. by sending data and control signals to the communication interface 820 and the storage medium 830, by receiving data and reports from the communication interface 820, and by retrieving data and instructions from the storage medium 830. Other components, as well as the related functionality, of the node 110 are omitted in order not to obscure the concepts presented herein.

FIG. 9 shows a Group Communications, GC, server node 110 comprising a central GC server 111, for synchronizing GC data between the central GC server 111 and a local GC server 230 comprised in a local GC server node 120, the GC server node comprising
a registration module Sxa1 arranged to perform a GC registration procedure in the central GC server 111 involving a GC client 310 comprised in a wireless device 140,
a receive module Sxa3 arranged to receive a location report related to a location of the wireless device 140,
an associate module Sxa4 arranged to associate the location report with a GC capability of the local GC server node 120 of providing GC involving the GC client 310, and
a transmit module Sxa7 arranged to transmit GC service data related to the GC client 310 to the local GC server 230.

According to aspects, the GC server node comprises
a receive module Sxa2 arranged to receive a group affiliation request associated with the GC client 310, from the wireless device 140.

According to aspects, the GC server node comprises
a transmit module Sxa5 arranged to transmit an indication to the wireless device 140 relating to a group communication capability of the local GC server node 120.

According to aspects, the GC server node comprises
a transmit module Sxa8 arranged to transmit a notification comprising data related to group affiliations associated with the GC client 310 to the local GC server 230.

FIGS. 10-11 schematically illustrate a wireless device hardware according to aspects of the present disclosure.

FIG. 10 schematically illustrates, in terms of a number of functional units, the components of a wireless device 140 according to an embodiment of the above discussions. Processing circuitry 1010 is provided using any combination of one or more of a suitable central processing unit CPU, multiprocessor, microcontroller, digital signal processor DSP, etc., capable of executing software instructions stored in a computer program product, e.g. in the form of a storage medium 1030. The processing circuitry 1010 may further be provided as at least one application specific integrated circuit ASIC, or field programmable gate array FPGA.

Particularly, the processing circuitry 1010 is configured to cause the Wireless device 140 to perform a set of operations, or steps. For example, the storage medium 1030 may store the set of operations, and the processing circuitry 1010 may be configured to retrieve the set of operations from the storage medium 1030 to cause the Wireless device 140 to perform the set of operations. The set of operations may be provided as a set of executable instructions. Thus, the processing circuitry 1010 is thereby arranged to execute methods as herein disclosed.

The storage medium 1030 may also comprise persistent storage, which, for example, can be any single one or combination of magnetic memory, optical memory, solid state memory or even remotely mounted memory.

The Wireless device 140 may further comprise a communications interface 1020 for communications with at least one external device. As such the communication interface 1020 may comprise one or more transmitters and receivers, comprising analogue and digital components and a suitable number ports for wireline or wireless communication.

The processing circuitry 1010 controls the general operation of the device 140 e.g. by sending data and control signals to the communication interface 1020 and the storage medium 1030, by receiving data and reports from the communication interface 1020, and by retrieving data and instructions from the storage medium 1030. Other components, as well as the related functionality, of the device 140 are omitted in order not to obscure the concepts presented herein.

FIG. 11 shows a wireless device 140 hardware comprising a Group Communication, GC, client 310 for synchronizing group communication data between a central GC server 111 and a local GC server 230 comprised in a local GC server node 120 in proximity of the wireless device, the wireless device comprising;
a perform module Sxb1 arranged to perform a GC registration procedure involving the GC client 310 and the central GC server 111,
a transmit module Sxb3 arranged to transmit a location report to the central GC server 111,
an obtain module Sxb4 arranged to obtain an indication relating to a group communication capability of the local GC server node 120.

According to aspects, the wireless device comprises a transmit module Sxb2 arranged to transmit a group affiliation request associated with the GC client 310 to the central GC server 111.

According to aspects, the wireless device comprises a receive module Sxb5 arranged to receive a response to the transmitted location report from the central GC server 111, wherein the response comprises data related to a group communication capability of the local GC server node 120.

According to aspects, the wireless device comprises a perform module Sxb6 arranged to perform a handshake procedure for group communication involving the GC client 310 and the local GC server 230 following a link outage between the local GC server node 120 and the central GC server 111, or between the GC client and the central GC server.

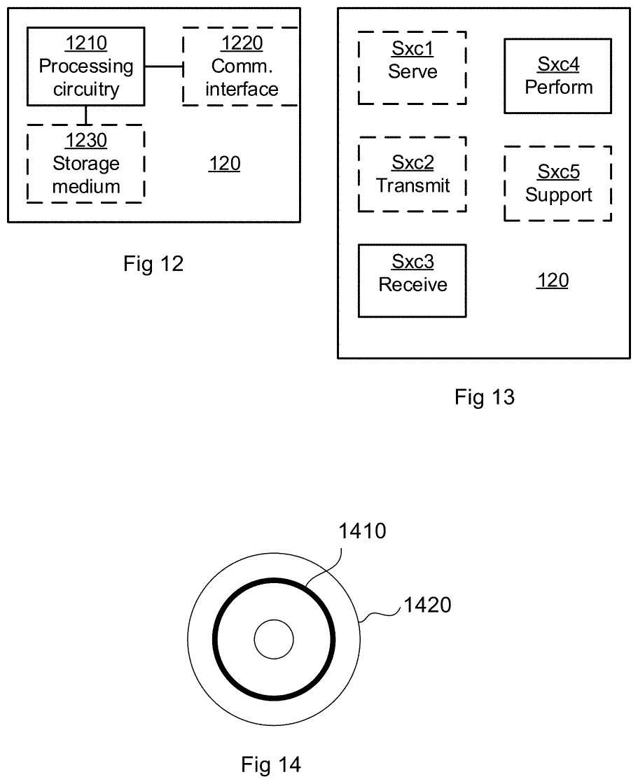

FIGS. 12-13 schematically illustrate a server node according to aspects of the present disclosure.

FIG. 12 schematically illustrates, in terms of a number of functional units, the components of a Local GC server node 120 according to an embodiment of the above discussions. Processing circuitry 1210 is provided using any combination of one or more of a suitable central processing unit CPU, multiprocessor, microcontroller, digital signal processor DSP, etc., capable of executing software instructions stored in a computer program product, e.g. in the form of a storage medium 1230. The processing circuitry 1210 may further be provided as at least one application specific integrated circuit ASIC, or field programmable gate array FPGA.

Particularly, the processing circuitry 1210 is configured to cause the Local GC server node 120 to perform a set of operations, or steps. For example, the storage medium 1230 may store the set of operations, and the processing circuitry 1210 may be configured to retrieve the set of operations from the storage medium 1230 to cause the Local GC server node 120 to perform the set of operations. The set of operations may be provided as a set of executable instructions. Thus, the processing circuitry 1210 is thereby arranged to execute methods as herein disclosed.

The storage medium 1230 may also comprise persistent storage, which, for example, can be any single one or combination of magnetic memory, optical memory, solid state memory or even remotely mounted memory.

The Local GC server node 120 may further comprise a communications interface 1220 for communications with at least one external device. As such the communication interface 1220 may comprise one or more transmitters and receivers, comprising analogue and digital components and a suitable number ports for wireline or wireless communication.

The processing circuitry 1210 controls the general operation of the node 120 e.g. by sending data and control signals to the communication interface 1220 and the storage medium 1230, by receiving data and reports from the communication interface 1220, and by retrieving data and instructions from the storage medium 1230. Other components, as well as the related functionality, of the node 120 are omitted in order not to obscure the concepts presented herein.

FIG. 13 shows a local GC server node 120 for synchronizing Group Communication, GC, data between a central GC server 111 and a local GC server 230 comprised in the local GC server node, comprising
a receive module Sxc3 arranged to receive GC service data related to the GC client 310 from the central GC server 111, and
a perform module Sxc4 arranged to, following a link outage between the local GC server node 120 and the central GC server 111, or between the GC client and the central GC server, perform a handshake procedure for group communication involving the GC client 310 and the local GC server 230.

According to aspects, the local GC server node 120 comprises a transmit module Sxc2 arranged to transmit an indication to the wireless device 140 relating to a group communication capability of the local GC server node.

According to aspects, the local GC server node 120 comprises a support module Sxc5 arranged to support a group communication involving the GC client 310 following link outage between the local GC server node 120 and the central GC server 111.

According to aspects, the local GC server node 120 comprises a serve module Sxc1 arranged to serve a wireless device 140 comprising a GC client 310, thereby providing a connection to the central GC server 111.

FIG. 14 schematically illustrates a computer readable medium 1420. The various aspects of the methods and techniques described herein are described in the general context of method steps or processes, which may be implemented in one aspect by a computer program product 1410, embodied in a computer-readable medium 1420, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1-40. (canceled)

41. A method in a Group Communications (GC) server node, the GC server node comprising a central GC server, the method for synchronizing GC data between the central GC server and a local GC server comprised in a local GC server node, the method comprising:
performing a GC registration procedure in the central GC server involving a GC client comprised in a wireless device;
receiving a location report related to a location of the wireless device;
associating the location report with a GC capability of the local GC server node providing GC involving the GC client; and
transmitting GC service data related to the GC client to the local GC server.

42. The method of claim 41, wherein the performing the GC registration procedure comprises performing an authentication procedure.

43. The method of claim 41, wherein the performing the GC registration procedure comprises performing a registration procedure according to 3GPP Mission Critical common architecture framework, TS 23.280 v 15.2.0.

44. The method of claim 41, further comprising receiving, from the wireless device, a group affiliation request associated with the GC client.

45. The method of claim 41, further comprising transmitting an indication to the wireless device relating to a group communication capability of the local GC server node.

46. The method of claim 41, further comprising transmitting, to the local GC server, a notification comprising data related to group affiliations associated with the GC client.

47. The method of claim 41, wherein the GC capability is an Isolated E-UTRAN operations for Public Safety capability.

48. The method of claim 41, wherein the local GC server node is a serving network node of the wireless device.

49. The method of claim 41, wherein the local GC server node is a network node in proximity to the wireless device.

50. The method of claim 41, wherein the GC service data comprises third party registration data.

51. A method, in a wireless device comprising a Group Communication (GC) client, for synchronizing group communication data between a central GC server and a local GC server, the local GC server comprised in a local GC server node located in proximity to the wireless device, the method comprising:
performing a GC registration procedure involving the GC client and the central GC server;
transmitting a location report to the central GC server;
obtaining an indication relating to a group communication capability of the local GC server node.

52. The method of claim 51, wherein the performing the GC registration procedure comprises performing an authentication procedure.

53. The method of claim 51, further comprising transmitting, to the central GC server, a group affiliation request associated with the GC client.

54. The method of claim 51, further comprising receiving a response to the transmitted location report from the central GC server, wherein the response comprises data related to a group communication capability of the local GC server node.

55. The method of claim 51, further comprising performing a handshake procedure for GC involving the GC client and the local GC server following a link outage between the local GC server node and the central GC server, or between the GC client and the central GC server.

56. The method of claim 51, wherein the group communication capability is an Isolated E-UTRAN operations for Public Safety capability.

57. The method of claim 51, wherein the local GC server node is a serving network node of the wireless device.

58. The method of claim 51, wherein the local GC server node is a network node located in proximity of the wireless device.

59. A method, in a local GC server node, for synchronizing Group Communication (GC) data between a central GC server and a local GC server comprised in the local GC server node, the method comprising:
receiving GC service data related to the GC client from the central GC server;
performing, following a link outage between the local GC server node and the central GC server, or between the GC client and the central GC server, a handshake procedure for group communication involving the GC client and the local GC server.

60. The method of claim 59, wherein the local GC server node comprises an evolved NodeB, a local Evolved Packet Core, and the local GC server.

61. The method of claim 59, further comprising transmitting, to the wireless device, an indication relating to a group communication capability of the local GC server node.

62. The method of claim 59, wherein the receiving GC service data comprises receiving data related to an authentication of the GC client.

63. The method of claim 59, wherein the receiving GC service data comprises receiving data related to a group affiliation of the GC client.

64. The method of claim 59, further comprising supporting a GC involving the GC client following link outage between the local GC server node and the central GC server.

65. The method of claim 59, wherein the local GC server node comprises an Isolated E-UTRAN operations for Public Safety capability.

66. The method of claim 59, wherein the local GC server node is a serving network node of the wireless device.

67. The method of claim 59, wherein the local GC server node is a network node in proximity to the wireless device.

68. The method of claim 59, wherein the GC service data comprises third party registration data.

69. A Group Communications (GC) server node having a central GC server, for synchronizing GC data between the central GC server and a local GC server comprised in a local GC server node, the GC server node comprising:
processing circuitry;
memory containing instructions executable by the processing circuitry whereby the GC server node is operative to:
perform a GC registration procedure in the central GC server involving a GC client comprised in a wireless device;
receive a location report related to a location of the wireless device;
associate the location report with a GC capability of the local GC server node providing GC involving the GC client; and
transmit GC service data related to the GC client to the local GC server.

70. A wireless device having a Group Communication (GC) client for synchronizing group communication data between a central GC server and a local GC server comprised in a local GC server node located in proximity to the wireless device, the wireless device comprising:
processing circuitry;
memory containing instructions executable by the processing circuitry whereby the wireless device is operative to:
perform a GC registration procedure involving the GC client and the central GC server;
transmit a location report to the central GC server; and
obtain an indication relating to a group communication capability of the local GC server node.

71. A local Group Communication (GC) server node for synchronizing GC data between a central GC server and a local GC server comprised in the local GC server node, the local GC server node comprising:
processing circuitry;
memory containing instructions executable by the processing circuitry whereby the local GC server node is operative to:
receive, from the central GC server, GC service data related to the GC client; and
perform, following a link outage between the local GC server node and the central GC server, or between the GC client and the central GC server, a handshake procedure for group communication involving the GC client and the local GC server.
